(19) United States
(12) Patent Application Publication
(10) Pub. No.: US 2025/0051517 A1
(43) Pub. Date: Feb. 13, 2025

(54) CATALYSTS FOR POLYLACTIDE PREPARATION

(71) Applicant: BROWN UNIVERSITY, Providence, RI (US)

(72) Inventors: Kerry C. Casey, Providence, RI (US); Jerome R. Robinson, Providence, RI (US)

(21) Appl. No.: 18/723,654

(22) PCT Filed: Jan. 5, 2023
(86) PCT No.: PCT/US2023/010184

§ 371 Date: Jun. 24, 2024

Related U.S. Application Data
(60) Provisional application No. 63/296,902, filed on Jan. 6, 2022.
(60) Provisional application No. 63/301,710, filed on Jan. 21, 2022.

(51) Int. Cl. C08G 63/82; C08G 63/08

(52) U.S. Cl. CPC C08G 63/823; C08G 63/08

(57) ABSTRACT

A catalytic compound of formula I, II, or III is described; wherein M is selected from the group consisting of Y, La, Ce, Pr, Nd, Sm, Eu, Gd, Tb, Dy, Ho, Er, Tm, Yb, and Lu; R¹, N is an integer from 1 to 3; R², R³, and R⁴ are independently selected from lower alkyl, lower alkoxy, C₅-C₈ aryl, and NR⁶₂, wherein R⁶ is —CH₃ or —C₂H₅; and R⁵ is selected from —H, lower alkyl, lower alkoxy, and benzylic. Methods of using the compound to catalyze the formation of polylactides, and polylactides prepared using these methods are also described.

### CROSS-REFERENCE TO RELATED APPLICATIONS

This application claims priority to U.S. Provisional Application Ser. No. 63/296,902, filed on Jan. 6, 2022, and U.S. Provisional Application Ser. No. 63/301,710, filed on Jan. 21, 2022, both of which are hereby incorporated by reference in their entirety.

### BACKGROUND

Mono- and multi-dentate phosphine oxides have enabled diverse applications of metal-ions across the periodic table including catalysis, separations, and polymerizations. Rare-earth ions (RE) display a rich coordination chemistry with these ligands (Mishra, S., Coordination Chemistry Reviews, 340, 62-78 (2017)), where the excellent hard-hard match and flexible coordination modes have led to the design of selective extractants, novel optical and magnetic materials, and highly active and selective complexes for organic and polymer synthesis Arnold et al., Angew. Chem, Int. Edit., 47, 6033-6036 (2008); Dong et al., Chem. Sci., 11, 8184-8195 (2020). Mono-anionic P-stabilized carbanions, such as bis(phosphine-oxide)methanides and bis(phosphonate)methanides are well-established reagents for the Horner-Wittig and Horner-Wadsworth-Emmons reactions, yet the isolation and characterization of complexes with these fragments (H^{R}L-, FIG. 1) have received limited attention. This is surprising given the ubiquity of the analogous beta-diketonate (AcAc, I)(Vigato et al., Chemistry Reviews, 253, 1099-1201 (2009)) and beta-diketiminate (NacNac, II) (Lappert, M., Severn, J., Chem. Rev, 102, 3031-3066 (2002)) ancillary ligands, and the more recent class of bis(phosphinimino)methanide ligands (III). Panda, T., Roesky, P., Chem. Soc. Rev., 38, 2782-2804 (2009).

Despite the utility of these “privileged” scaffolds, they behave as largely unreactive ancillary ligands due to either their largely delocalized anionic charge (I and II) or larger steric profile (II and III). However, the incorporation of multiple Lewis- and/or Brønsted acid/base fragments within metal complexes have led to cooperative or multifunctional reactivity (Deng et al., RSC Adv., 3, 11367-11384 (2013)); which has been exploited with great success in the fields of asymmetric catalysis and frustrated Lewis-pairs.

Polylactic acid (PLA) is a thermoplastic aliphatic polyester derived from renewable sources such as corn starch, sugar cane, or sugar beet pulp. At present, PLA has the highest consumption volume of any bioplastic, and is widely used in 3D printing. The most common route to preparing PLA is the ring-opening polymerization of lactide with various metal catalysts. Sun et al., J. Mol. Catal. A: Chem., 393, 175-181 (2014). However, the catalysts current used to produce PLA have a number of limitations, such as the inability to tolerate impurities in the reaction mixture. Accordingly, there remains a need for improved catalysts for the preparation of PLA.

### SUMMARY OF THE INVENTION

The inventors have identified and synthesized homoleptic yttrium and lanthanum complexes of bis(phosphine-oxide)methanides H^{R}L (R=Me, Ph; RE(H^{Ph}L)₃ and RE₂(H^{Me}L)₆. Initial studies suggested that these complexes could be capable of multifunctional reactivity (Lewis-acid/Brønsted-base), which could be exploited to promote a range of stoichiometric and catalytic processes. Further studies have revealed that the complexes are capable of generating novel, random copolymers of PLA from simple polyols through transesterification. Transesterification can proceed under mild conditions (e.g., ambient conditions), and such an approach can provide access to PLA having significantly different mechanical, thermal, and degradation profiles. Under some conditions, Ultra-High Molecular Weight (UHMW) Polylactic Acid (PLA) can be prepared. It also makes use of inexpensive polyols, and can take advantage of very low catalyst loadings, and requires less monomer purification, both of which offer cost and operational advantages.

### BRIEF DESCRIPTION OF THE FIGURES

The present invention may be more readily understood by reference to the following figures wherein:

FIG. 1 provides a schematic representation of (Top) Privileged monoanionic fragments β-diketonates (I, AcAc), β-diketiminates (II, NacNac), and bis(phosphinimide)methanides (III), and the corresponding bis(phosphine-oxide)methanides (HRL-) explored in this manuscript. (Bottom) Homoleptic RE^{III} complexes of HRL- and relevant attributes.

FIG. 2 provides a schematic representation of the synthesis of RE(H^{Ph}L)₃ and RE₂(H^{Me}L)₆.

FIG. 3 provides graphs showing the mechanical properties of thin films of PLLA (L-polylactic acid) with varying molecular weights prepared by Y(H^{Ph}L)₃. Samples: M_{w}=262 kDa, Ð=1.09; M_{w}=705 kDa, Ð=1.31; M_{w}=2,056 kDa, Ð=1.09.

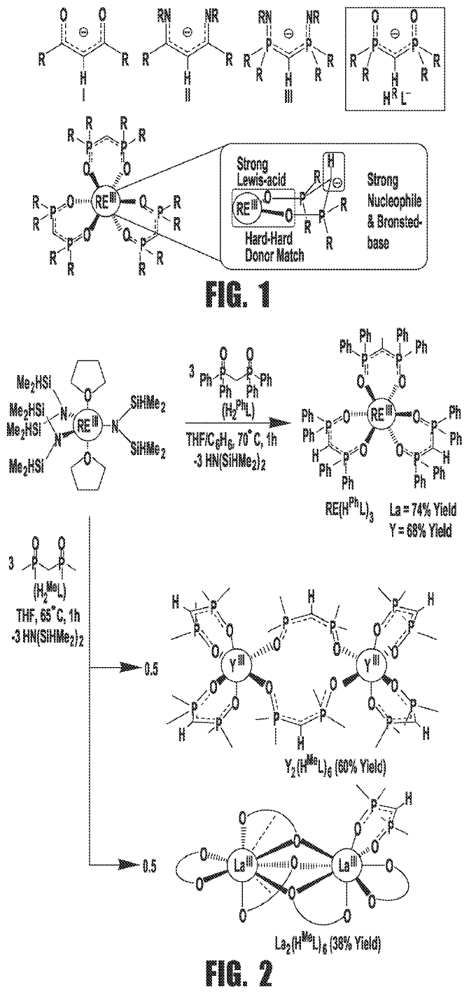

### DETAILED DESCRIPTION OF THE INVENTION

This disclosure provides a catalytic compound of formula I, II, or III; wherein Mⁿ⁺ is selected from the group consisting of Y, La, Ce, Pr, Nd, Sm, Eu, Gd, Tb, Dy, Ho, Er, Tm, Yb, and Lu; R¹, R², R³, and R⁴ are independently selected from lower alkyl, lower alkoxy, C₅-C₈ aryl, and NR⁶₂, wherein R⁶ is —CH₃ or —C₂H₅; and R⁵ is selected from —H, lower alkyl, lower alkoxy, and benzylic. Methods of using the compound to catalyze the formation of polylactides, and polylactides prepared using these methods are also provided.

### Definitions

Unless otherwise defined, all technical and scientific terms used herein have the same meaning as commonly understood by one of ordinary skill in the art to which this invention pertains. In case of conflict, the present specification, including definitions, will control.

The terminology as set forth herein is for description of the embodiments only and should not be construed as limiting of the invention as a whole. Unless otherwise specified, “a,” “an,” ““the,” and “at least one” are used interchangeably. Furthermore, as used in the description of the invention and the appended claims, the singular forms “a”, “an”, and “the” are inclusive of their plural forms, unless contraindicated by the context surrounding such.

Also herein, the recitations of numerical ranges by endpoints include all numbers subsumed within that range (e.g., 1 to 5 includes 1, 1.5, 2, 2.75, 3, 3.80, 4, 5, etc.).

As used herein, the term “about,” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

As used herein, the term “organic group” is used for the purpose of this invention to mean a hydrocarbon group that is classified as an aliphatic group, cyclic group, or combination of aliphatic and cyclic groups (e.g., alkaryl and aralkyl groups). In the context of the present invention, suitable organic groups for polylactide catalysts are those that do not interfere with the compound's catalytic activity. In the context of the present invention, the term “aliphatic group” means a saturated or unsaturated linear or branched hydrocarbon group. This term is used to encompass alkyl, alkenyl, and alkynyl groups, for example.

As used herein, the terms “alkyl”, “alkenyl”, and the prefix “alk-” are inclusive of straight chain groups and branched chain groups and cyclic groups, e.g., cycloalkyl and cycloalkenyl. Unless otherwise specified, these groups contain from 1 to 20 carbon atoms, with alkenyl groups containing from 2 to 20 carbon atoms. In some embodiments, these groups have a total of at most 10 carbon atoms, at most 8 carbon atoms, at most 6 carbon atoms, or at most 4 carbon atoms. Lower alkyl groups are those including at most 6 carbon atoms. Examples of alkyl groups include haloalkyl groups and hydroxyalkyl groups. Alkyl groups can be substituted or unsubstituted.

Unless otherwise specified, “alkylene” and “alkenylene” are the divalent forms of the “alkyl” and “alkenyl” groups defined above. The terms, “alkylenyl” and “alkenylenyl” are used when “alkylene” and “alkenylene”, respectively, are substituted. For example, an arylalkylenyl group comprises an alkylene moiety to which an aryl group is attached.

The term “haloalkyl” is inclusive of groups that are substituted by one or more halogen atoms, including perfluorinated groups. This is also true of other groups that include the prefix “halo-”. Examples of suitable haloalkyl groups are chloromethyl, trifluoromethyl, and the like. A halo moiety can be chlorine, bromine, fluorine, or iodine.

Cycloalkyl groups are cyclic alkyl groups containing 3, 4, 5, 6, 7 or 8 ring carbon atoms like cyclopropyl, cyclobutyl, cyclopentyl, cyclohexyl or cyclooctyl, which can also be substituted and/or contain 1 or 2 double bounds (unsaturated cycloalkyl groups) like, for example, cyclopentenyl or cyclohexenyl can be bonded via any carbon atom.

A heterocyclyl group means a mono- or bicyclic ring system in which one or more carbon atoms can be replaced by one or more heteroatoms such as, for example, 1, 2 or 3 nitrogen atoms, 1 or 2 oxygen atoms, 1 or 2 sulfur atoms or combinations of different hetero atoms. The heterocyclyl residues can be bound at any positions, for example on the 1-position, 2-position, 3-position, 4-position, 5-position, 6-position, 7-position or 8-position.

The term “aryl” as used herein includes carbocyclic aromatic rings or ring systems. Examples of aryl groups include phenyl, naphthyl, biphenyl, anthracenyl, phenanthracenyl, fluorenyl and indenyl. Aryl groups may be substituted or unsubstituted.

Unless otherwise indicated, the term “heteroatom” refers to the atoms O, S, or N.

The term “heteroaryl” includes aromatic rings or ring systems that contain at least one ring heteroatom (e.g., O, S, N). In some embodiments, the term “heteroaryl” includes a ring or ring system that contains 2 to 12 carbon atoms, 1 to 3 rings, 1 to 4 heteroatoms, and O, S, and/or N as the heteroatoms. Suitable heteroaryl groups include furyl, thienyl, pyridyl, quinolinyl, isoquinolinyl, indolyl, isoindolyl, triazolyl, pyrrolyl, tetrazolyl, imidazolyl, pyrazolyl, oxazolyl, thiazolyl, benzofuranyl, benzothiophenyl, carbazolyl, benzoxazolyl, pyrimidinyl, benzimidazolyl, quinoxalinyl, benzothiazolyl, naphthyridinyl, isoxazolyl, isothiazolyl, purinyl, quinazolinyl, pyrazinyl, 1-oxidopyridyl, pyridazinyl, triazinyl, tetrazinyl, oxadiazolyl, thiadiazolyl, and so on.

When a group is present more than once in any formula or scheme described herein, each group (or substituent) is independently selected, whether explicitly stated or not. For example, for the formula —C(O)—NR₂ each R group is independently selected.

The terms “group” and “moiety” are used herein to differentiate between chemical species that allow for substitution or that may be substituted and those that do not so allow for substitution or may not be so substituted. Thus, when the term “group” is used to describe a chemical substituent, the described chemical material includes the unsubstituted group and that group substituted with nonperoxidic O, N, S, Si, or F atoms, for example, in the chain as well as carbonyl groups or other conventional substituents. Where the term “moiety” is used to describe a chemical compound or substituent, only an unsubstituted chemical material is intended to be included. For example, the phrase “alkyl group” is intended to include not only pure open chain saturated hydrocarbon alkyl substituents, such as methyl, ethyl, propyl, tert-butyl, and the like, but also alkyl substituents bearing further substituents known in the art, such as hydroxy, alkoxy, alkylsulfonyl, halogen atoms, cyano, nitro, amino, carboxyl, etc. Thus, “alkyl group” includes ether groups, haloalkyls, nitroalkyls, carboxyalkyls, hydroxyalkyls, sulfoalkyls, etc. On the other hand, the phrase “alkyl moiety” is limited to the inclusion of only pure open chain saturated hydrocarbon alkyl substituents, such as methyl, ethyl, propyl, tert-butyl, and the like.

The compounds described herein in any of the isomers (e.g., diastereomers and enantiomers) of the compounds. In particular, if a compound is optically active, the invention specifically includes each of the compound's enantiomers as well as racemic mixtures of the enantiomers. For example, polylactides can include both the D and L forms of lactic acid.

### Catalytic Compounds

In one aspect, the present invention provides a catalytic compound of formula I, II, or III:

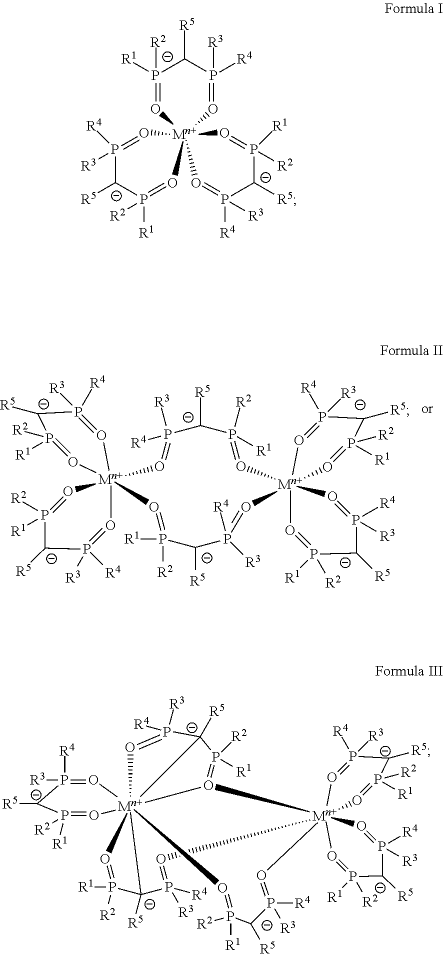

wherein M is selected from the group consisting of Y, La, Ce, Pr, Nd, Sm, Eu, Gd, Tb, Dy, Ho, Er, Tm, Yb, and Lu; N is an integer from 1 to 3;
R¹, R², R³, and R⁴ are independently selected from lower alkyl, lower alkoxy, C₅-C₈ aryl groups, which can be substituted or unsubstituted, and NR⁶₂, wherein R⁶ is —CH₃ or —C₂H₅; and
R⁵ is selected from —H, lower alkyl, lower alkoxy, and benzylic groups, which can be substituted or unsubstituted.

Mⁿ⁺ of formula I, II, and III refers to a Rare Earth (RE) metal atom having a oxidation state of n. N is an integer which can range from 1 to 3. Mⁿ⁺ can also be referred to as a RE metal having a specific positive charge. For example, RE^{III} refers to a rare earth element having an oxidation state of 3. Suitable rare earth metals include Yttrium (Y), Lanthanum (La), Cerium (Ce). Praseodymium (Pr), Neodymium (Nd), Samarium (Sm). Europium (Eu). Gadolinium (Gd), Terbium (Tb), Dysprosium (Dy), Holmium (Ho), Erbium (Er), Thulium (Tm), Ytterbium (Yb), and Lutetium (Lu). In some embodiments, M is yttrium or lanthanum.

In some embodiments, R¹, R², R³, and R⁴ are C⁵-C⁸ aryl groups. In further embodiments, R¹, R², R³, and R⁴ are lower alkyl or lower alkoxy. In yet further embodiments, R⁵ is —H. Because of the greater steric hindrance present in the catalysts of Formula II and III, in some embodiments, R¹—R⁴ of formula I are phenyl, while R¹—R⁴ of formulas II or III are methyl.

In some embodiments, the compound is according to Formula I, while in other embodiments the compound is according to Formula II. In further embodiments, the compound is according to Formula III. In yet further embodiments, the compound is according to formula II or III.

One of the advantages of the present invention is that the catalysts do not require the high level of monomer purity required of polylactide catalysts described in the prior art. Prior art catalysts typically require monomer purity very close to 100%. For example, prior art methods used to produce relatively low molecular weight UHMW-PLA requires lactide that has been recrystallized 3-6 times and then sublimed. See Chellali et al., ACS Catal. 2022, 12, 5585-5594, and Li et al., ACS Omega 2020, 38, 24230-24238, for a description of the high level of purity required by prior art methods. The catalyst described herein require a lower level of monomer purity from 98.0% to 99.9%, or from 98.5% to 99.5%.

### Polylactides

One aspect of the invention provides a polylactide prepared by contacting a lactide monomer with a catalytic compound according to formula I, II, or III. A polylactide is a thermoplastic polyester with backbone formula (C₃H₄O₂)n or [—C(CH₃)HC(═O)O-]n, formally obtained by condensation of lactic acid C(CH₃)(OH)HCOOH with loss of water. It can also be prepared by ring-opening polymerization of lactide [—C(CH₃)HC(═O)O-]₂, the cyclic dimer of the basic repeating unit. Typical polylactides have a molecular weight ranging from about 10³ to about 10⁵ grams/mol.

One of the main drawbacks of PLA is its brittle nature and relatively low mechanical properties, which can limit its use for some (e.g., medical) applications. The mechanical properties of polymers can typically be improved by increasing the molecular weight of the polymer chains. Accordingly, in some embodiments, the polylactide is a high or ultra-high molecular weight polylactide. High molecular weight polylactides have a molecular weight greater than 10⁵ grams/mol, whereas ultra-high molecular weight polylactides have a molecular weight greater than 10⁶ grams/mol. (e.g., 1100 to 1400 kg/mol).

In some embodiments, the PLA is transesterified by reacting it with an alcohol. Transesterification is the exchange of an R group of an alcohol with the R′ group of an ester. As a result of transesterification, the catalyst generates random copolymers of PLA from the simple alcohol (e.g., polyol) from which the polylactide polymer is formed. This can result in the formation of PLA having different mechanical, thermal, and degradation profiles.

In some embodiments, the method of preparing the polylactic acid includes the step of contacting (i.e., reacting) the lactide with an alcohol such that the alcohol comprises a polylactide end group. Unlike transesterification, this results in a modification of only the ends of the polymer strands of the polylactide.

The polydispersity (Ð) describes the degree of “non-uniformity” of a distribution. Polymers prepared that have a smaller range of lengths and molecular weight values exhibit a lower polydispersity. One of the advantages of the claimed method is the ability to prepare polylactides, and in particular high and ultra-high molecular weight polylactides having a relatively low polydispersity value. Accordingly, in some embodiments, the polylactide has a polydispersity ranging from 1.1 to 2.1, while in further embodiments, the polylactide has a polydispersity ranging from 1 to 1.6.

The catalytic compound used to prepare the polymer can be any of the catalytic compounds described herein. In some embodiments, M of the catalytic compound used to prepare the polylactide is yttrium or lanthanum. In further embodiments, the catalytic compound used to prepare the polylactide is according to Formula I, while in yet further embodiments the catalytic compound used to prepare the polylactide is according to formula II, or formula III.

### Methods of Making a Polylactide

Another aspect of the invention provides a method of making a polylactide. The method includes the step of contacting a lactide monomer with a rare-earth ion bis(phosphine-oxide) methanide catalytic compound according to formula I, II, or III. The bis(phosphine-oxide) methanide catalytic compound according to formula I, II, or III can have any of the characteristics described herein for the compounds of formula I, II, or III. The monomers are reacted by ring-opening polymerization to form the polylactide polymer.

In some embodiments, the monomer is contacted with the catalytic compound at a temperature ranging from 20° C. to 30° C. In further embodiments, the polylactide is an ultra-high molecular weight polylactide. In additional embodiments, the amount of catalytic compound ranges from 50 ppm to 600 ppm or 100 ppm to 300 ppm. In yet further embodiments, M of the catalytic compound is yttrium or lanthanum.

In some embodiments, the lactide or the polylactide are further reacted with an alcohol. Reacting the polylactide with an alcohol increases the variety of characteristics that can be obtained for the polylactides. The alcohol can initiate the ring opening polymerization of lactide to generate polylactic acid with an end-group comprising the alcohol, or modify the polylactic acid through transesterification. The alcohol reacted with the lactide or polylactide can be a monohydric alcohol, a diol, or a polyol. A monohydric alcohol is an organic compound in which only one —OH group is attached to an aliphatic carbon chain. A diol (i.e., dihydric alcohol) is an organic compound in which only two —OH groups are attached to an aliphatic group. Preferably, the monohydric or dihydric alcohols are organic compounds having from 3 to 12 carbon atoms, or in some embodiments, from 3 to 6 carbon atoms. Polyols include, for example, low molecular weight polyols, sugar alcohols, and polymeric polyols.

As described herein, an advantage of the catalysts described herein is their ability to prepare polylactides from monomers of relatively lower purity. In some embodiments, the monomer has a purity from 98.0% to 99.9%).

The lactide monomers are reacted by ring-opening polymerization to form the polylactide polymer. The polylactides can be prepared using bulk polymerization, or solution polymerization. In bulk polymerization, the catalyst is added directly to the monomer (e.g., lactic acid) in a liquid state. In solution polymerization, on the other hand, the monomer (e.g., lactic acid) is dissolved in a suitable solvent before being contacted with the catalyst. The range of reaction conditions suitable for preparing the polylactide will vary depending on the method of polymerization used, the particular catalyst being used, and the nature of the polylactide being prepared.

### Solution Polymerization Conditions—Purified Monomer

In some embodiments, the polylactide is prepared using solution polymerization using a purified monomer (e.g., lactide). General conditions for solution polymerization including carrying out the reaction at a temperature ranging from about 20 to about 30° C. (e.g., room temperature) in a suitable organic solvent (e.g., CH₂Cl₂) for a reaction time ranging from about 3 minutes to about 6 hours, or in some embodiments from about 10 minutes to about 3 hours. The monomer concentration can be from about 0.1 to about 1.0 M (e.g., 0.5 M). The ratio of monomer to catalyst ranges from about 1000:1 to about 60,000:1, which correspond to catalyst concentrations ranging from about 5.0·10⁻⁴ M to 8.33·10⁻⁶ M.

### Solution Polymerization Conditions—Unpurified Monomer

In some embodiments, the polylactide is prepared using solution polymerization using a purified monomer (e.g., lactide). General conditions for solution polymerization including carrying out the reaction at a temperature ranging from about 20 to about 30° C. (e.g., room temperature) in a suitable organic solvent (e.g., CH₂Cl₂) for a reaction time ranging from about 5 minutes to about 30 minutes, or from about 10 minutes to about 15 minutes. In some embodiments, a chain transfer agent (CTA; e.g., diphenylmethanol) can be included in the reaction mixture, using about 2 to about 5 (e.g., 3) equivalents. The monomer concentration can be from about 0.1 to about 1.0 M (e.g., 0.5 M). A higher amount of catalyst is required compared to the reaction using purified monomer. A monomer to catalyst ratio of up to 1:500 can be used.

### Bulk Polymerization—Purified Monomer

In some embodiments, the polylactide is prepared using bulk polymerization using a purified monomer (e.g., lactide). The reaction can be carried out at a temperature from about 125 to about 150° C. (e.g., 140° C.) for a period of time ranging from 2 to 5 (e.g., 3) minutes. For example, using Y(H^{OiPr}L)₃, a monomer to initiator (i.e., catalyst) (M/I) ratio=1000/1, a reaction temperature of 140° C. for 3 minutes resulted in 80% conversion, Mₙ=26.14 kg mol⁻¹, Ð=2.01.

### Conditions for Ultra-High Molecular-Weight Polylactide (UHMW-PLA)

The range of molecular weights that can be achieved with this system, including with chain transfer agent, are 2.89 kg mol⁻¹ to (at least) 1600 kg mol⁻¹. UHMW-PLA can be produced with Y(H^{OiPr}L)₃ and Y(H^{Ph}L)₃ catalysts at a wide range of M/I ratios from 1000:1 to 40,000:1. The catalyst Y(H^{Me}L)₃ can produce UHMW-PLA at M/I ratios from about 5,000 to 20,000:1 (e.g., 10,000:1, M_{w}=487 kg mol⁻¹). UHMW-PLA can also be produced using unpurified lactide and the Y(H^{OiPr}L)₃ catalyst.

### Inclusion of Chain-Transfer Agents (CTA)

Chain transfer agents have at least one weak chemical bond that facilitates the chain transfer reaction during polylactide synthesis. Diphenylmethanol (HOCHPh₂) and isopropanol (HOⁱPr) can be used as chain transfer agents. General conditions for solution polymerization using a CTA are the same as solution polymerizations without CTA. Catalysts are able to tolerate up to about 50 equiv. of CTA.

Examples have been included to more clearly describe particular embodiments of the invention. However, there are a wide variety of other embodiments within the scope of the present invention, which should not be limited to the particular examples provided herein.

### Examples

### Preparation of Yttrium and Lanthanum Bis(Phosphine-Oxide)Methanides

Herein we report the synthesis, characterization, and initial reactivity of homoleptic Y^{III} and La^{III} complexes of H^{R}L-, RE(H^{Ph}L)₃ and RE₂(H^{Me}L)₆. Our combined experimental and computational studies reveal rich structural diversity that is dictated by R-group and RE^{III}, where the complexes are highly fluxional in solution, even at −80° C. RE(H^{Ph}L)₃ and RE₂(H^{Me}L)₆ feature strongly nucleophilic and Brønsted-basic methanides, which lead to the first RE-promoted Horner-Wittig reaction and rapid reactivity of Y(H^{Ph}L)₃ and Y₂(H^{Me}L)₆ with MeOH/MeOD. Our preliminary reactivity studies suggest that these complexes may be capable of multifunctional reactivity (Lewis-acid/Brønsted-base), which might be exploited to promote a range of stoichiometric and catalytic processes.

### Synthesis and Characterization of RE(H^{Ph}L)₃ and RE₂(H^{Me}L)₆

The novel homoleptic bis(phosphine-oxide)methanide complexes, RE(H^{R}L)₃ and RE₂(H^{Me}L)₆ (FIG. 2), were synthesized in one step via protonolysis with 3 equiv bis(phosphine-oxide)methane, H₂^{R}L (R=Me, Ph), and one equiv RE^{III}[N(SiHMe₂)₂]₃(THF)₂ (RE^{III}=Y^{III}, La^{III}). Smith, A. and Livinghouse, T, Organometallics, 32, 1528-1530 (2013). All compounds were found to be sensitive to air and moisture. Although the products display reasonable solubility in non-polar aprotic solvents, the protonolysis reaction required the addition of THF and mild heating (˜65-70° C., 1 h) due to the poor solubility of H₂^{R}L. For further discussion of the preparation and characterization of yttrium and lanthanum bis(phosphine-oxide)methanides, see Casey et al., Inorg. Chem Front, 8(6), 1539-1552 (2021), the disclosure of which is incorporated herein by reference.

### Synthesis of Methylenebis(Dimethylphosphine Oxide), H₂^{Me}L

In an N₂-filled glovebox a 50 mL Schlenk flask was charged with bis(dimethylphosphino)methane (500 mg, 3.67 mmol, 1 equiv, MW: 136.11 g·mol⁻¹), toluene (3 mL), and a Teflon coated stir bar. The flask was sealed, taken out of the glovebox, and an inert atmosphere was established on the Schlenk line. The Schlenk flask was cooled to 0° C., and hydrogen peroxide (37% w/w, 1.68 mL, ρ=1.10 g/mL; 1.85 g, 14.70 mmol, 4 equiv, MW: 34.01 g·mol⁻¹) was added dropwise (2 min) to the vigorously stirring colorless solution. The clear biphasic solution was allowed to warm to RT over 16 h, after which the solvent was removed under reduced pressure. Toluene (8 mL) was added to the clear, colorless oil and the flask was fitted with a dean stark trap. The biphasic solution was heated to reflux for 16 h to remove residual water. Upon completion of the azeotropic distillation, the solution was cooled to RT under N₂ flow to yield clear, colorless crystals upon standing (2 h). The solvent was removed under reduced pressure (16 h, 50 mTorr), and the white solid was then transferred to a sublimator in an N₂-filled glovebox. The sublimator was brought back outside the glovebox and the hygroscopic white solid was then sublimed (110° C., 50 mTorr) to yield anhydrous bis(dimethylphosphine-oxide)methane, H₂^{Me}L, as a white solid. Yield: 385.5 mg (2.29 mmol, 62%; MW: 168.11 g·mol⁻¹).

### Synthesis of Y₂(H^{Me}L)₆

A 20 mL scintillation vial was charged with bis(dimethylphosphine-oxide)methane, H₂^{Me}L, (102.7 mg, 0.61 mmol, 3 equiv, MW: 168.11 g·mol⁻¹), Y[N(SiHMe₂)₂]₃(THF)₂ (128.3 mg, 0.20 mmol, 1 equiv, MW: 630.12 g·mol⁻¹), tetrahydrofuran (3 mL), and a Teflon-coated stir bar. The light-yellow mixture solution was stirred for 1 h at 65° C., and solvents were removed under reduced pressure. The crude yellow solid was triturated with pentane (3×1 mL) to help remove residual amine. The yellow was dissolved in diethyl ether (5 mL) and filtered through a glass pipet padded with Celite® to remove insoluble materials. Volatiles were removed under reduced pressure and the yellow oily solid was dissolved in diethyl ether (2 mL). Clear crystals formed after sitting undisturbed at −35° C. for 2 h. The solvent was decanted, the solid was washed with RT pentane (1 mL), and the sample was dried under reduced pressure to yield Y₂(H^{Me}L)₆ as a white solid. Yield: 72.4 mg (0.126 mmol, 60%; MW: 590.22 g·mol⁻¹).

### Synthesis of La₂(H^{Me}L)₆

A 20 mL scintillation vial was charged with H₂MeL (117.0 mg, 0.70 mmol, 3 equiv, MW: 168.11 g·mol⁻¹), La[N(SiHMe₂)₂]₃(THF)₂ (157.8 mg, 0.23 mmol, 1 equiv, MW: 680.12 g·mol⁻¹), tetrahydrofuran (3 mL), and a Teflon-coated stir bar. The light-yellow mixture solution was stirred for 1 h at 65° C., and solvents were removed under reduced pressure. The crude yellow solid was triturated with pentane (3×1 mL) to help remove residual amine. The yellow was dissolved in diethyl ether (5 mL) and filtered through a glass pipet padded with Celite® to remove insoluble materials. Volatiles were removed under reduced pressure and the resulting yellow oily solid was dissolved in pentane (2 mL). Clear, colorless crystals formed after sitting undisturbed at −35° C. for 2 h. The solvent was decanted, the solid was washed with cold pentane (1 mL, −35° C.), and the sample was dried under reduced pressure to yield La₂(H^{Me}L)₆ as a white solid. Yield: 53.0 mg (0.08 mmol, 36%; MW: 640.22 g·mol⁻¹). X-ray quality crystals were acquired by slow diffusion of pentane into a concentrated diethyl ether solution.

### Synthesis of Y(H^{Ph}L)₃

A 20 mL scintillation vial was charged with bis(diphenylphosphine-oxide)methane, H2PhL, (627.3 mg, 1.51 mmol, 3 equiv, MW: 416.40 g·mol⁻¹), Y[N(SiHMe₂)₂]₃(THF)₂ (316.4 mg, 0.50 mmol, 1 equiv, MW: 630.12 g·mol⁻¹), benzene (3 mL), tetrahydrofuran (3 mL), and a Teflon-coated stir bar. The light-yellow mixture was stirred for 1 h at 70° C., and solvents were removed under reduced pressure. The crude light-yellow solid was triturated with pentane (3×1 mL) to help remove residual amine. The yellow was dissolved in toluene (4 mL), and tetrahydrofuran (1 mL), and filtered through a glass pipet padded with Celite® to remove insoluble materials. The clear light-yellow solution was layered with pentane (4 mL). Clear, colorless crystals formed after sitting undisturbed at RT for 24 h. The solvent was decanted, the solid was washed with pentane (3 mL), and the sample was dried under reduced pressure to yield Y(H^{Ph}L)₃ as a white solid. Yield: 454.9 mg (0.34 mmol, 68%; MW: 1335.1 g·mol⁻¹).

### Synthesis of La(H^{Ph}L)₃

A 20 mL scintillation vial was charged with H₂^{Ph}L (367.5 mg, 0.88 mmol, 3 equiv, MW: 416.40 g·mol⁻¹), La[N(SiHMe₂)₂]₃(THF)₂ (316.4 mg, 0.29 mmol, 1 equiv, MW: 680.12 g·mol⁻¹), benzene (3 mL), tetrahydrofuran (3 mL), and a Teflon-coated stir bar. The light-yellow mixture was stirred for 1 h at 70° C., and solvents were removed under reduced pressure. The crude light-yellow solid was triturated with pentane (3×1 mL) to help remove residual amine. The yellow was dissolved in toluene (4 mL), and tetrahydrofuran (1 mL), and filtered through a glass pipet padded with Celite® to remove insoluble materials. The clear light-yellow solution was layered with pentane (4 mL). Clear colorless crystals formed after sitting undisturbed at room temperature for 24 h. The solvent was decanted, the solid was washed with pentane (3 mL), and the sample was dried under reduced pressure to yield La(H^{Ph}L)₃ as a white solid. Yield: 302.2 mg (0.34 mmol, 74%; MW: 1385.1 g·mol⁻¹).

All of the complexes displayed simple ¹H, ¹³C, and ³¹P{¹H} NMR spectra consistent with at least C₃ symmetry in solution at RT. Protonolysis of H₂^{R}L results in shielding of the resulting methanide hydrogen and carbon by greater than 1 and 10 ppm in the ¹H and ¹³C{¹H} NMR spectra, respectively (Table 1). Similar to rare-earth bis(phosphinimino)methanides and alkali-metal bis(phosphine-oxide)methanides, ¹J_{C-P} values roughly doubled in the RE^{III} complexes coordinated by H^{R}L- compared to free H₂^{R}L.

TABLE 1
Collected NMR spectroscopic data

| | δ ¹H: | δ ¹³C{¹H}: | δ ³¹P{¹H}: |
|---|---|---|---|
| | PC(H)P | PC(H)P | PC(H)P |
| Complex | (²J_{H-P}, Hz)^{a} | (¹J_{C-P}, Hz) | (²J_{P-Y}, Hz) |
| H₂^{Ph}L | 3.53 (14.1) | 34.3 (58.9) | 23.6 |
| Y(H^{Ph}L)₃ | 2.27 (2.0) | 21.3 (111.8) | 37.8 (5.8) |
| La(H^{Ph}L)₃ | 2.28^{c} | 22.9 (111.2) | 35.4 |
| [La(H₂^{Ph}L)₄]³⁺ | 3.30 (12) | — | 33.5 |
| H₂^{Me}L | 2.23 (13.1) | 35.2 (56.5) | 36.3 |
| Y₂(H^{Me}L)₆ | 0.91 (6.3) | 21.1 (117.1) | 46.4 (6.1) |
| | 0.90 (7.4)^{b} | 20.4 (123.5) | 45.5 (6.1) |
| La₂(H^{Me}L)₆ | 1.20 (6.6)^{b} | 23.1 (117.3) | 40.7 |

^{a}Performed in CD₂Cl₂ unless noted otherwise.
^{b}C₆D₆.
^{c}CH resonance is too broad at room temperature to calculate.

Y(H^{Ph}L)₃ and Y₂(H^{Me}L)₆ are members of a new class of multifunctional RE^{III} compounds, which can act as kinetically competent Lewis-acids, Brønsted-bases, and nucleophiles. Our initial reactivity studies present the first RE-mediated Horner-Wittig reaction, which proceeded rapidly at RT to access (E)-styrenylphosphine-oxides. Furthermore, Y(H^{Ph}L)₃ and Y₂(H^{Me}L)₆ readily deprotonate MeOH and MeOD, which is predicted to be thermodynamically unfavorable based on the pKa of MeOH and H₂^{R}L alone. The facile and quantitative reactivity supports cooperative Lewis-acid activation and deprotonation for Y(H^{Ph}L)₃ and Y₂(H^{Me}L)₆, where the effective pKa value of MeOH can be lowered by >6 orders of magnitude.

### Example 2: Ring-Opening Polymerization of Rac-Lactide

### Lactide Source

Racemic (Rac)-lactide (99%, Sigma-Aldrich) was recrystallized twice from dry toluene in the glovebox. A 1 g/10 mL mixture of toluene and rac-lactide was heated to 100° C. until all lactide has dissolved then was allowed to cool to room temperature for at least 4 hours before filtering over a medium porosity glass frit. Residual toluene was removed under reduced pressure at room temperature.

Representative Polymerization of Rac-Lactide without Chain-Transfer Agent

In a glovebox, a 4 mL scintillation vial was charged with a CH₂Cl₂ solution of Y(H^{Me}L)₃ (1% m/m, 0.023 mL, ρ=1.33 g mL⁻¹, 0.31 mg, 0.0005 mmol, 1.0 equiv; MW=590.22 g mol⁻¹). A Teflon-coated stir bar was added and the total volume was brought up to 0.463 mL by an additional volume of CH₂Cl₂ (0.440 mL). To the rapidly stirring solution of Y(H^{Me}L)₃ was added a solution of rac-Lactide in CH₂Cl₂ (10% m/m, 0577 mL, ρ=1.30 g mL⁻¹, 75.0 mg, 1.04 mmol, 1000.0 equiv; MW=144.13 g mol⁻¹). The reaction was allowed to stir at room temperature for 3 minutes and then was quenched with a solution of benzoic acid in CH₂Cl₂ (2% m/m, 0.040 mL).

Representative Polymerization of Rac-Lactide with Chain-Transfer Agent (Ex. HOCHPh₂)

In a glovebox, a 4 mL scintillation vial was charged with a CH₂Cl₂ solution of Y(H^{Me}L)₃ (1% m/m, 0.023 mL, ρ=1.33 g mL⁻¹, 0.31 mg, 0.0005 mmol, 1.0 equiv; MW=590.22 g mol⁻¹). A Teflon-coated stir bar was added and a CH₂Cl₂ solution of diphenylmethanol (1% m/m, 0.022 mL, ρ=1.33 g mL⁻¹, 0.29 mg, 0.0016 mmol, 3.0 equiv; MW=184.24 g mol⁻¹) was added. The total volume was brought up to 0.463 mL by an additional volume of CH₂Cl₂ (0.418 mL). The colorless CH₂Cl₂ solution was stirred for 2 minutes and a solution of rac-Lactide in CH₂Cl₂ (10% m/m, 0.577 mL, ρ=1.30 g mL⁻¹, 75.0 mg, 1.04 mmol, 1000.0 equiv; MW=144.13 g mol⁻¹) was added. The reaction was allowed to stir at room temperature for 3 minutes and then was quenched with a solution of benzoic acid in CH₂Cl₂ (2% m/m, 0.040 mL).

### Example 3: Representative Large-Scale Polymerization

In a glovebox, a 500 mL round-bottom flask was charged with L-lactide (7.52 g, 52.18 mmol, 10,000 equiv, MW=144.13 g·mol⁻¹), dichloromethane (103 mL), and a Teflon-coated stir bar. A dichloromethane solution of Y(H^{Ph}L)₃ (1% m/m, 0.524 mL, ρ=1.33 g·mL⁻¹, 6.97 mg, 0.0052 mmol, 1.0 equiv; MW=1335.07 g·mol⁻¹) was added to the rapidly stirring solution of L-lactide. The colorless solution was allowed to stir at room temperature for 90 minutes and then was quenched by the addition of a dichloromethane solution of benzoic acid (5% w/w, 0.96 mL). the flask was taken out of the glovebox and, if necessary, an additional volume of dichloromethane (150 mL) was added to reduce the viscosity of the solution before precipitation. To precipitate the polymer, cold (0° C.) isopropanol (30 mL/g of polymer) was added to the stirring solution of polymer. After precipitation, the solvent was decanted and the resulting white solid was dried under reduced pressure (˜100 mTorr) with gentle heat (50° C.) for 6-12 hours. The precipitation was repeated once more by dissolving the dried polymer in dichloromethane (250 mL) and precipitating with cold (0° C.) isopropanol (250 mL). Note: Ultrahigh molecular weight PLLA can take ˜2 d to fully dissolve. The solvent was decanted, and the polymer was dried under reduced pressure reduced pressure (˜100 mTorr) and gentle heat (50° C.) for 16 hours to yield PLLA as a white solid. Yield: 6.21 g (83%). The catalyst used was according to Formula I, wherein R¹—R⁴=Ph, R⁵=H, and Mⁿ⁺=Y³⁺.

### Preparation of Solvent Cast PLLA Films

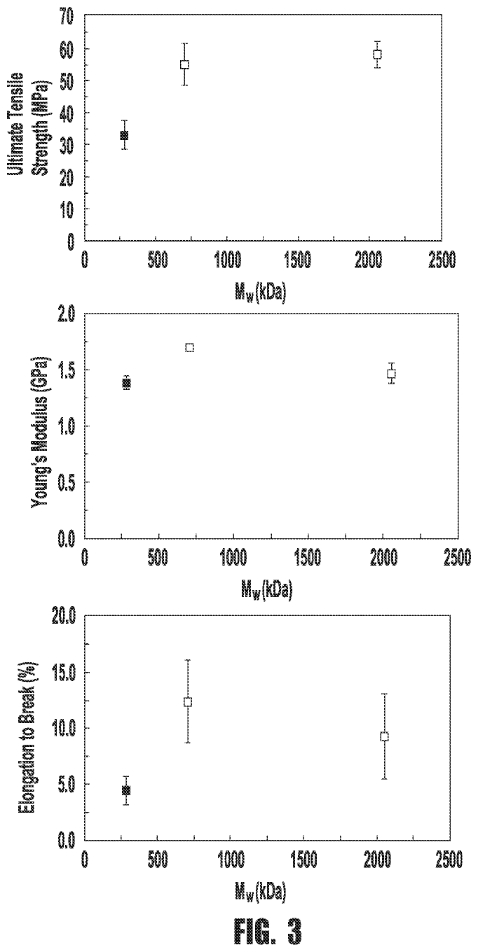

2.5 g of PLLA was weighed out in a crystallizing dish (190 mm×100 mm) and dissolved in 250 mL dichloromethane. The crystallizing dish was covered and left until the PLLA had completely dissolved. To ensure an even distribution of PLLA and to eliminate possible bubble formation in the film, the solution was stirred gently with a metal spatula. After waiting for the appropriate amount of time the crystallizing dish was left uncovered in a fume hood overnight to let the solvent slowly evaporate. The resulting PLLA film was peeled from the crystallization dish without damaging it and the film was then annealed in a vacuum oven at 110° C. for 48 h. Note: Ultra-high molecular weight PLLA can take up to 2 days to fully dissolve. The mechanical properties of the PLLA films preparing using this procedure are shown in FIG. 3.

The complete disclosure of all patents, patent applications, and publications, and electronically available material cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

What is claimed is:

1. A catalytic compound of formula I, II, or III: 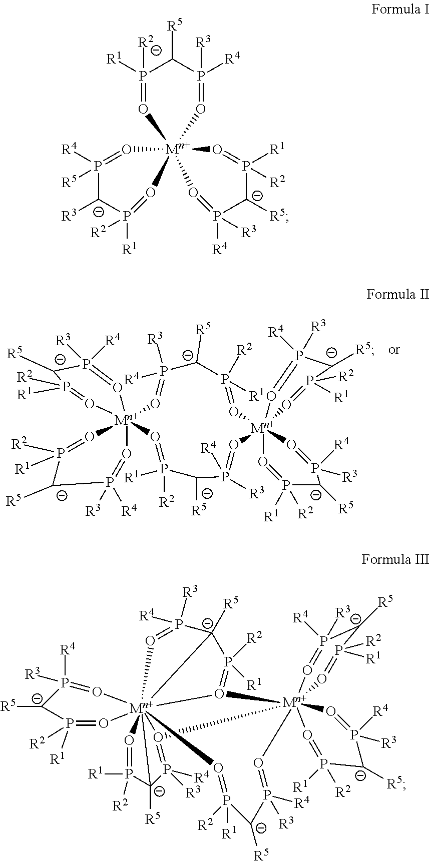
wherein M is selected from the group consisting of Y, La, Ce, Pr, Nd, Sm, Eu, Gd, Tb, Dy, Ho, Er, Tm, Yb, and Lu; N is an integer from 1 to 3;
R¹, R², R³, and R⁴ are independently selected from lower alkyl, lower alkoxy, C₅-C₈ aryl groups, which can be substituted or unsubstituted, and NR⁶₂, wherein R⁶ is —CH₃ or —C₂H₅; and
R⁵ is selected from —H, lower alkyl, lower alkoxy, and benzylic. groups, which can be substituted or unsubstituted.

2. The compound of claim 1, wherein R¹, R², R³, and R⁴ are phenyl and R⁵ is —H.

3. The compound of claim 1, wherein R¹, R², R³, and R⁴ are methyl and R⁵ is —H.

4. The compound of claim 1, wherein M is yttrium or lanthanum.

5. The compound of claim 1, wherein the compound is according to Formula I.

6. The compound of claim 1, wherein the compound is according to Formula II or Formula III.

7. A method of making a polylactide, comprising contacting a lactide monomer with a catalytic compound of claim 1.

8. The method of claim 7, wherein the method further comprises contacting the lactide monomer with an alcohol.

9. The method of claim 7, wherein the lactide monomer is contacted with the catalytic compound at a temperature ranging from 20° C. to 30° C.

10. The method of claim 7, wherein the polylactide is an ultra-high molecular weight polylactide.

11. The method of claim 7, wherein the amount of catalytic compound ranges from 100 ppm to 300 ppm.

12. The method of claim 7, wherein M of the catalytic compound is yttrium or lanthanum.

13. The method of claim 7, wherein the catalytic compound is according to Formula I.

14. The method of claim 7, wherein the monomer has a purity from 98.0% to 99.9%.

15. A polylactide prepared by contacting a lactide monomer with a catalytic compound of claim 1.

16. The polylactide of claim 15, wherein the lactide monomer is contacted with an alcohol that is bonded to both ends of the polylactide.

17. The polylactide of claim 15, wherein the polylactide is an ultra-high molecular weight polylactide.

18. The polylactide of claim 15, wherein the polylactide is transesterified with an alcohol.

19. The polylactide of claim 15, wherein M of the catalytic compound used to prepare the polylactide is yttrium or lanthanum.

20. The polylactide of claim 15, wherein the catalytic compound used to prepare the polylactide is according to Formula I.

21. The polylactide of claim 15, wherein the polylactide has a polydispersity ranging from 1.1 to 2.1

22. The polylactide of claim 15, wherein the polylactide has a polydispersity ranging from 1 to 1.6.
